(19) United States
(12) Patent Application Publication
(10) Pub. No.: US 2004/0255167 A1
(43) Pub. Date: Dec. 16, 2004

(54) Method and system for remote network security management

(76) Inventor: James Michael Knight, Glendale, AZ (US)

Correspondence Address: LEWIS AND ROCA, LLP, 40 N. CENTRAL AVE., PHOENIX, AZ, 85004, US

(21) Appl. No.: 10/834,443

(22) Filed: Apr. 28, 2004

Related U.S. Application Data
(60) Provisional application No. 60/466,347, filed on Apr. 28, 2003.

(51) Int. Cl. G06F 11/30

(52) U.S. Cl. 713/201; 709/224

(57) ABSTRACT

There is presented a method and system for remotely managing and protecting computer networks from unauthorized intrusion and hacking attacks. The present invention allows a remote security management center to provide many of the monitoring and protection functions traditionally carried out by an information technology support center located at a particular network site. The remote center can monitor a protected network and intervene to thwart hacking or viral/worm attacks against the separate protected network through the global network attached to the protected network (e.g. Internet).

### CROSS REFERENCES TO RELATED APPLICATIONS

This application claims the full benefit and priority of U.S. Provisional Application Ser. No. 60/466,347, filed on Apr. 28, 2003, the disclosure of which is fully incorporated herein for all purposes.

### STATEMENT REGARDING FEDERALLY SPONSORED RESEARCH OR DEVELOPMENT

Not applicable.

### BACKGROUND OF THE INVENTION

1. Field of the Invention

The present invention relates to a system and method for managing a computer network from a remote installation. More specifically, the method and system of the present invention integrates a collection of network security techniques to present a comprehensive and high-security approach to network security.

2. Background

As long as computer networks with public access points have existed, hackers and interlopers have attempted to attack and disrupt network operations, or to gain unauthorized access to sensitive information. Over time, a variety of point solutions have been implemented to attempt to counter these threats, yet no effective comprehensive solution had been achieved. As our reliance upon computer networks as a medium for information interchange continues to grow, so does the need to reduce the vulnerability of networks to intrusion or unauthorized access.

The security of many networks has been shown to be increasingly vulnerable to attack and disruption from both internal and external sources. Improved security technology is needed involving more comprehensive and sophisticated techniques for prevention as well as detection of attacks. Networks are clearly vulnerable and this new technology is needed now. Security threats are real and pervasive as indicated by the following examples: (a) the 2003 Computer Crime and Security Survey published by the FBI and Computer Security Institute found that 69% of all companies reported attacks by external hackers in the last 12 months; (b) a Gartner Group survey shows over 50% of enterprises using the Internet will be attacked by hackers; and, (c) according to IDS, a new DSL connection receives three attempted “hacks” in the first 48 hours.

Security threats come in a variety of forms and almost always result in a serious disruption to a network. Hackers can gain unauthorized access by using a variety of readily available tools to break into the network. The hacker no longer needs to be an expert or understand the vulnerabilities of the network—they only need to select a target and attack, and once in, the hacker has control of the network. Denial of Service (DoS) and Distributed Denial of Service (DDoS) attacks aim to disable a device or network so users no longer have access to network resources. Using trojan horses, worms, or other malicious attachments, hackers can plant these tools on countless computers. Viruses can attach to email and other applications and damage data and cause computer crashes. Users increase the damage by unknowingly downloading and launching them. Viruses are also used as delivery mechanisms for hacking tools, putting the security of the organization in doubt, even if a firewall is installed. Hackers can deploy sniffers to capture private data over networks without the users of this information being aware that their confidential information has been tapped or compromised.

There is a significant need for an effective network security technology that can prevent rather than just detect intrusions. This need has been verified in recent studies as of extreme urgency. New network cyberspace security measures (via the Homeland Security Act) have further increased the urgency for networks at all levels to conform. This raises the necessity for a proven, effective remote management security system model that can be commercially applied to all levels of network users from individual and small business to large corporation, government and military.

The following sections provide a background of the features, characteristics, components, and functionality of the currently available but unintegrated network security technologies.

Firewalls

Firewalls are the first component of any perimeter defense. Firewalls perform the critical task of filtering traffic crossing the network boundary. This filtering is done according to predefined security policies, which can be specified at the network or application layer. However, firewalls do not provide adequate perimeter protection since they must pass legitimate traffic.

The main deficiency of the firewall is the use of static manually configured policies to differentiate legitimate traffic from non-legitimate traffic. These policies can vary in effectiveness, depending on the expertise of the security manager and the complexity of the network environment. Once a static policy is defined, the firewall cannot react to a network attack, nor can it initiate effective counter-measures. If a policy makes a certain network service available, it will remain available even if that service is used to mount an attack. In other words, firewalls may be strong, but they cannot respond to security incidents as they occur. There are four categories of firewalls: NAT Boxes, Packet Filters, Application-Level Proxy Servers, and Stateful Packet Inspection Firewalls.

Many self-proclaimed “firewalls” are nothing more than “NAT boxes,” which perform Network Address Translation (NAT). NAT allows networks to use a single public IP address to connect to the Internet, thereby keeping private the IP addresses of the LAN computers.

However, NAT does not constitute a secure firewall because they are easily bypassed by “IP spoofing” and they lack the necessary logging and reporting features of firewalls for monitoring network security. NAT alone is not adequate for protecting network resources.

Packet filter firewalls are typically implemented in DSL or Ethernet routers and examine data passing over the network using rules to block access according to information located in each packet's addressing information. Packet filter firewalls are vulnerable to a number of hacker attacks, not to mention difficult to set up and maintain.

Proxy servers or session-level firewalls examine the upper level of IP packets. While this approach is superior to packet filtering, significant performance degradation to broadband Internet connections can result. Also, proxy servers can be difficult to set up and maintain for non-technical users.

Stateful Packet Inspection firewalls have replaced both packet filters and proxy servers as the most trusted firewall technology. Stateful Packet Inspection is a more sophisticated firewall technology based on advanced packet-handling that is transparent to users on the LAN, requires no client configuration, and secures the widest array of IP protocols. The Stateful Packet Inspection firewall intercepts packets until it has enough to make a determination as to the secure state of the attempted connection. Stateful Packet Inspection is also better suited to protect networks against Denial of Service (DoS) and Distributed Denial of Service (DDoS) attacks.

Virus Protection

A virus is a program which attaches itself to, overwrites, or otherwise replaces another program in order to reproduce itself. It must attach itself to a host program, usually an executable file, to replicate. Computer viruses are a leading security threat to networks. Viruses have become the most prolific and costly security issue, and the problem is getting worse each year. Destructive viral programs can infect any attributes of any components of a network. Viruses damage data, cause computer crashes, or lie dormant like a time bomb that explodes at some future event. Users with infected machines unwittingly spread damaging viruses throughout a network. Viruses can also be used as delivery mechanisms even if a firewall is installed.

Today, there are over 65,000 known viruses with another 200 to 800 discovered each month. Virus infections have increased steadily from 1 per 100 computers in 1996 to 9 per 100 computers this year. Over 99% of all companies have been infected with at least one virus in the past 12 months, and over half of all companies have experienced a virus disaster. These virus infections come at a significant cost to companies, including resources required for cleanup and lost productivity.

The manner in which a virus becomes active depends on how the virus has been designed. The prominent virus types are Macro, Boot and Parasitic. Macro viruses infect macros in popular applications like Microsoft Word. When the macro is executed, it becomes part of the application. Any document on that computer using the same application is then infected. If the infected computer is on a network, the infection spreads rapidly to other computers on the network. Boot sector viruses infect computers by modifying the contents of the boot sector program with its own infected version. The result for the user is no access to the computer's operating system and data. Parasitic viruses attach themselves to executable programs.

Many networks have virus protection, but are still vulnerable because of the challenge of keeping virus protection up to date. Anti-virus scanners rely on a database of all known viruses in order to be effective in detecting the latest viruses. Because many anti-virus scanners rely on users to keep these updates current, a serious gap exists in maintaining network-wide anti-virus protection. In a recent survey, 25% of all users neglected to install or update their anti-virus software. When a new virus is discovered, all anti-virus software deployed within an organization must be quickly updated with the latest virus definition files. Upon a widespread outbreak of a new virus, users without the most current virus definition files allow these viruses to multiply and infect many other users and networks. Anti-virus solutions fall into four categories: single-user desktop software, managed virus protection service, enforced virus protection, and server-based virus protection.

Single-user desktop anti-virus software is traditionally installed and maintained on each computer on a network. Desktop anti-virus software combat viruses received from email, Internet downloads, and portable media such as floppy disks. Desktop anti-virus software users can easily remove, reduce scanning threshold, or disable the software if they feel the performance of their system is being adversely affected.

Managed anti-virus programs function at the gateway level. Downloads and emails are scanned at the gateway (the entrance to the network). Gateway anti-virus programs are easier to manage than basic desktop scanning programs. However, they do not scan the source of a large number of all viruses: portable media and LAN-based infections. Also, the extra scanning required at the gateway level will slow the processing of network traffic.

Policy enforced virus protection has all the advantages of the desktop and the managed anti-virus methods, without any of the disadvantages. Automatically updated anti-virus software is maintained on each desktop by the firewall. When users attempt to access the network, the firewall checks to verify the user's PC has the latest version of the virus scanning engine installed and active. In the event of out-of-date or deactivated anti-virus software, the firewall automatically updates and activates the virus protection. The users' computers are then secure against viruses in email, downloads and portable media.

Server-based anti-virus protection adds the virus scanner software to the server acting as the Internet gateway or an email server on the local network. An email anti-virus solution resides on the email server and scans all email attachments for viruses. The gateway anti-virus solution resides on the server being used as the gateway and scans all data traffic for viruses. Server-based anti-virus provides robust virus protection designed to scan all traffic traveling across the network, but it is expensive because it requires intensive IT resources to manage the anti-virus system. Combining email server and anti-virus with an enforced network anti-virus solution provides the highest level of protection currently available.

Content Filtering

Content filtering allows organizations to set and enforce Acceptable Use Policies (AUP) governing what materials can and cannot be accessed on the organization's computers. Without content filtering, network users have unlimited access to all resources, whether appropriate or inappropriate, whether benign or dangerous. Creating and enforcing network access policies enables the blocking of incoming content and filtering out of any sources of offensive material.

Content filtering can be accomplished using text screening, proxy lists, or URL Blocking. Test screening stops pages from loading when the filter words on a predefined list are encountered in either the URL or body of a page. Proxy lists are implemented via client software that only allows access to approved sites, or implemented via centralized proxy servers that pre-load all approved content. All clients access the proxy server instead of accessing the network directly. The proxy server then connects to the net to download the latest content. URL Blocking provides content filtering per lists provided by a content filtering organization. Editors review selections before adding them to the filter list. URL Blocking is the preferred method of content filtering because it blocks objectionable or inappropriate content while preserving access to other resources.

WEP Authentication

The security provided by WEP (Wired Equivalency Privacy) of 802.11 is limited to authentication and encryption at the MAC layers. The original goal of IEEE in defining WEP was to provide the equivalent security of an “unencrypted” wired network. But wired networks are somewhat protected by physical buildings they are housed in, whereas wireless networks are not.

WEP does provide authentication to the network and encryption of transmitted data across the network. However, the WEP shared key system and the WEP encryption algorithm are the most widely discussed vulnerabilities of WEP. Furthermore, several manufacturers' implementations have introduced additional vulnerabilities to the WEP standard. WEP uses the RC4 algorithm known as a stream cipher for encrypting data utilizing a 64-bit key. Some manufacturers tout larger 128-bit keys, but the problem is not the length of the key. The problem is that WEP allows secret identification, which means the network can be exploited at any key length. Hence, stronger authentication and encryption methods are being deployed such as Wireless VPNs with RADIUS servers.

RADIUS Servers

Remote Authentication Dial-In User Service Systems (RADIUS) are used to manage authentication, accounting, and access to network resources. A RADIUS server provides stronger authentication and encryption methods than the default WEP authentication security provided by the 802.11 wireless LAN standard. RADIUS systems manage authentication, accounting, and access to network resources. Mutual authentication wireless VPNs offer strong authentication and overcome some of the weaknesses in WEP.

Virtual Private Network (VPN) Functionality

Virtual Private Network (VPN) is an umbrella term that refers to all the technologies enabling secure communications over the public Internet. VPN-related technologies include tunneling, authentication, and encryption. VPN uses secure “tunnels” between two gateways to protect private data as it travels over the Internet.

Tunneling is the process of encapsulating and encrypting data packets to make them unreadable as they pass over the Internet. A VPN tunnel through the Internet protects all data traffic passing through, regardless of the application. From the VPN user's perspective, a VPN operates transparently melding their computer desktop at home with the resources of the office network. Email, databases, Intranets, or any application can pass through a VPN tunnel.

A VPN uses data encryption to provide high performance, secure communications between sites without incurring the expense of leased site-to-site lines, or modem banks and telephone lines. A VPN enables the establishment of secure communications in a manner that is transparent to end-users. A VPN can connect individual telecommuters to the office network, creating a separate, secure tunnel for each connection, or a VPN can connect remote office networks together as a LAN-to-LAN connection over the Internet using a single data tunnel.

Internet Protocol Security (IPSec) is a standards-based protocol that offers flexible solutions for secure data communications across public networks, and enables interoperability between VPN products. IPSec is built around a number of standardized cryptographic techniques to provide confidentiality, data integrity, and authentication. Digital certificates add even more security to VPN connections by allowing businesses to authenticate individuals wanting access to confidential company resources.

As new deployments of Wireless LANs proliferate, hackers are identifying security flaws and developing techniques to exploit them. Sophisticated hackers can use long-range antennas to pick up 802.11b signals from up to 2,000 feet away. Many manufacturers ship wireless LAN Access Points (AP) with the WEP disabled by default and are never changed before deployment. Some of the APs even beacon the company name into the airwaves as the Service Set IDentifier (SSID).

Since the security provided by WEP alone is extremely vulnerable, stronger authentication and encryption methods should be deployed such as Wireless VPNs using RADIUS servers. The VPN layer employs strong authentication and encryption mechanisms between the wireless access points and the network. With the popularity of Wireless LANs growing, new attacks are being developed. Strategies that worked before need to be reviewed to address new vulnerabilities. Wireless attacks that can be applied to VPNs and RADIUS systems include session hijacking attacks and man-in-the-middle attacks.

Session hijacking can be accomplished by first monitoring a valid wireless station by authenticating to the network with a protocol analyzer. Then the attacker will send a spoofed disassociate message from the AP causing the wireless station to disconnect. The wireless station and AP are not synchronized, which allows the attacker to disassociate the wireless station. Meanwhile, the AP is unaware that the original wireless station is not connected. The man-in-the-middle attack involves an attacker that acts as an AP to the user and as a user to the AP, thus putting himself in the middle. The man-in-the-middle attack works because 802.1x uses only one-way authentication. There are proprietary extensions available now from some vendors that enhance 802.1x to defeat this vulnerability.

Intrusion Detection System

Intrusion detection sensors in the WLAN detect inappropriate, incorrect, or anomalous activity, and can respond to both external attacks and internal misuses. An intrusion detection capability generally includes three functional components: (1) a stream source that provides chronological event information; (2) an analysis mechanism that determines potential or actual intrusions; and (3) a response mechanism that takes action on the output of the analysis mechanism.

A stream source can be a remote sensor that monitors the airwaves and generates a stream of 802.11 frame data to the analysis mechanism. The analysis mechanism must differentiate between normal traffic and real intrusions. False positive alarms and false negative alarms can severely hamper the credibility of the IDS. The techniques for analysis are either signature-based or anomaly-based. Signature-based techniques produce accurate results but can be limited to historical attack patterns. Anomaly techniques can detect unknown attacks by analyzing normal traffic patterns of the network but are less accurate than the signature-based techniques.

The IDS provides vulnerability assessment by identifying known vulnerabilities in the network. For each Access Point in the network, the following information comprises the baseline for the IDS to protect: the MAC address, the Extended Service Set name, the manufacturer, the supported transmission rates, the authentication modes, the IPSEC configuration, and the identity of each workstation equipped with a wireless interface card. With this information, the IDS can then determine rogue AP's and identify wireless stations by vendor fingerprints.

Security policies are defined for the Wireless LAN to provide the network administrator with a map of the network security model for effectively managing the network. Security policies provide the IDS with the thresholds to be set for acceptable network operations such as: AP and wireless station configurations, authorized APs, configuration parameters, allowable channels of operation, and normal activity hours of operation for each AP. No security policy fits all environments or situations.

For intrusion detection to be effective, the state must also be maintained between the wireless stations and their interactions with Access Points. The three basic states for the 802.11 model are idle, authentication, and association.

Finally, a multi-dimensional approach to intrusion detection is required because no single technique can detect all intrusions that can occur on a wireless LAN. A successful multidimensional intrusion detection approach integrates the quantitative techniques of signature recognition, policy deviation, protocol analysis, and pattern anomaly detection.

Shortcomings of Typical Intrusion Detection Systems

The Network-based intrusion detection system (IDS) triggers alerts by detecting either anomalous traffic patterns or signatures that are characteristic of an attack. However, the typical IDS has several shortcomings that limit its usefulness in protecting the network.

The first shortcoming is the generation of “false positives” which alerts about an attack when none is taking place. False positives waste the valuable analysis time and create a “cry wolf” environment in which real attacks maybe ignored. When an IDS is installed, it is common for more than 90% of its alerts to be false positives. This hypersensitivity can be reduced by “tuning down” the system and making it more selective, but this will not eliminate false positives altogether because false positives are inherently a part of signature-oriented intrusion detection schemes or any other type of anomaly detection system. The unavoidability of false positives means that an IDS cannot be used to trigger automated corrective actions, because that action could trigger the automatic blocking of normal traffic.

Another shortcoming of the typical IDS is its dependency on attack traffic signatures. Attackers are creative and ever innovative. An IDS that relies exclusively on documented attack profiles will always be vulnerable to new, undocumented attacks. Another shortcoming is that an IDS is fundamentally reactive. When a real attack does take place, the IDSs only alert security managers that something is wrong. It is then up to the security team to take remedial action. Even a short time between the alert and remediation can result in irreversible damage to the network. Finally, IDS can be extremely administration-intensive. Highly skilled security professionals must constantly tune the system, update signatures, analyze alerts to determine if they are real or false and then respond with appropriate remedial action.

Honeypot Intrusion Detection Mechanism

A Honeypot is an intrusion detection mechanism that attempts to lure attackers by presenting a more visible and apparently more vulnerable resource than the network itself. Honeypots are useful for detecting attacks, since they provide a single point for security professionals to monitor for evidence of anomalous activity. They are also useful in retaining significant data pertaining to an attack. However, honeypots are not necessarily effective at attack prevention because sophisticated attackers can target the honeypot as well as any other component of the network. In fact, if honeypots are incorrectly configured, they can actually make the enterprise more vulnerable to attack by virtue of being logically associated with it.

Prevention vs. Detection

Attacks are preceded by a phase of information collection referred to as the reconnaissance phase. Attackers scan and probe the target network for potential vulnerabilities to determine which type of attack to attempt. Reconnaissance is an integral and essential part of any attack because attackers need information about the topology of the network, about accessible network services, about software versions, about valid user/password credentials, and about anything else to launch a successful attack. Without such information, it is virtually impossible to successfully attack a network. Unlike attacks themselves, reconnaissance can only be performed in some very basic ways. Current reconnaissance techniques share some basic attributes including: TCP/UDP port scan, NetBIOS probes, SNMP probes, and other probes.

The TCP/UDP port scan technique accounts for about 70% of all recon activity. The attacker operates at the network layer, mapping open TCP or UDP ports on network hosts. This is extremely valuable information, since it reveals any applications running on the host that are accessible from the network. The NetBIOS probe technique interrogates an IP host for computer names, user names, shared resources (such as shared folders or printers), and so forth. Responses to such probes will disclose the fact that the probed IP host actually runs a NetBIOS layer, and will reveal the objects sought by the attacker.

The SNMP probe technique capitalizes on the Simple Network Management Protocol (SNMP), which is used almost universally for communication between networked devices and management consoles. SNMP carries information about the nature, configuration, topology, and health of those devices. As a result, attackers can gain valuable information about all types of network resources. Several other recon methods (e.g. HTTP-based probes, “finger” probes, DNS zone transfers, and SMTP-based interrogation) are also in use and more methods are likely as hackers are constantly redefining and mutating their methods.

Typically, attackers use a variety of recon techniques. With each successive recon, the attacker gains more detail about the network's vulnerabilities (e.g. an unpatched service, a visible NetBIOS resource, an open FTP port, etc). Even when recon yields no data, the attacker learns something about the network (e.g. a host is not easily accessible). This helps the attacker further refine the attack strategy. A typical attack has three stages: (1) the recon activity performed by the attacker; (2) the return of recon information to the attacker; and, (3) the attack itself launched based on that recon information.

Understanding this three-stage attack process is central to effective defense. Security managers can take advantage of inherent flaws in the attack process to actually thwart attacks before they reach the firewall or the ID system behind it. Just as attackers exploit vulnerabilities in the network to mount attacks, security managers can exploit vulnerabilities in the attach process to protect themselves.

Intrusion Prevention System (IPS)

The commercially available Intrusion Prevention System by Fore Scout proactively responds to attackers' reconnaissance activity and neutralizes attacks using a three-phase process:

Phase 1: Receptor. The IPS functions as a passive monitor by non-obtrusively listening to incoming network traffic, looking for any signs of network reconnaissance. This monitoring is done so that even slow scans will be detected. This can be done because false positives are not an issue. During this stage, the IPS also sees which network services and resources are visible to the outside world (i.e. can be seen outside the firewall).

Phase 2: Deceptor: When reconnaissance activity is detected, the IPS automatically shifts to its active mode and identifies the type of recon being used by the suspected attacker and will respond to the recon with information similar to that which is being sought.

However, the information supplied by the IPS is purposely counterfeit. It looks exactly like the type of data that would have been supplied by a real target, but is actually “deceptor” data provided to mislead the attacker. The potential attacker then uses it in any subsequent attack.

This deceptor data will be very different from that supplied by a honeypot. Honeypots are real resources that are accurately pinpointed by recon activity. However, the deceptor data provided by this IPS gives the attacker false data about resources that do not actually exist. Also, deceptor data can specifically mimic all types of resources that may be targeted for an attack. Honeypots do not provide this level of mimicry.

It is important to note that up to this point, no alarm has been triggered. The security at the RMC does not have to respond to any situation or try to interpret complex traffic data. The deceptor data has been automatically sent to the suspected attacker and recorded in the IPS database. The network continues to operate without disruption. In most cases, the deceptor phase will be the last one in the response cycle. While almost all attacks start with a scan, very few scans will actually result in an attack. A typical site may be scanned hundreds or even thousands of times per day, but there might only be a dozen or fewer real attacks during the same time period, so there will be no need for Phase 3.

However, the security team will not lose anything by responding to these scans. There should be no unnecessary bandwidth utilization. In fact, it will not matter if the IPS responds with deceptor data to traffic that turns out not to even be a scan at all. The entire process is completely innocuous for the valid traffic occurring simultaneously on the network.

Phase 3: Interceptor: The attack information, of course, contains the deceptor data provided by the IPS. Because the attacker is using the deceptor data, the IPS can immediately identify the attack when it occurs (rather than depend on an attack signature).

In other words, the IPS plants a “mark” by which it can detect and intercept traffic coming from a source that previously performed suspicious reconnaissance, and can thus be acted upon immediately and automatically, regardless of whether or not it conforms to any type of known attack pattern. Only at this point does this IPS system generate an alarm with a high degree of confidence that a real attack has been launched. Alerts can take the form of email, an SNMP trap, a line in a log, a pager message and/or any other appropriate type of message. All traffic from the offending IP address can be blocked for a predefined period of time as well. This blocking can be done by the IPS or in conjunction with the firewall.

Although an attack may take place days or weeks after the scanning activity and may come from a totally different IP address than the scan, the IPS solution will be just as effective, because it's unaffected by a time delay or a “moving source.” This solution represents a radical innovation in information security technology and practice. It should represent a significant and innovative advance in the protection of critical network assets from the increasingly diverse and frequent external threats.

The need for an effective network security technology, especially a technology that can prevent hostile intrusions rather than just detect them, has been made clear. This need has been most dramatically emphasized in an article published in Network World titled, “Crying Wolf: False Alarms Hide Attacks.” In this paper, eight Intrusion Detection Systems were evaluated during a month-long test on a production network. The overall conclusion as that none of the eight IDSs performed well against even common intrusions, and some generated so many false alarms as to render their true alarms ineffective.

The importance of achieving an effective remote management security model can hardly be overstated. Information networks are crucial to homeland security and to the security of the world and must not be vulnerable. Thus, what is also needed is an integrated, comprehensive approach to manage network security against a variety of attack modes. What is further needed is a method to manage networks using commercial, off-the shelf (COTS) tools and components to provide comprehensive network security in a cost-effective manner. What is further needed is a system and method that allows for managing security at a plurality of remote cites without the need for security personnel to be present at each site.

Hence, the need for proven, effective network security products at all network levels is not only a reality, but of extreme urgency. Furthermore, the network cyberspace security measures that have been defined (via the Homeland Security Act) have further increased the urgency for networks at all levels to conform by providing at least a minimum amount of protection.

### BRIEF DESCRIPTION OF THE PREFERRED EMBODIMENT

It is an object of the present invention to provide a comprehensive solution to monitor and manage network security through a remote management center (RMC) that monitors and controls one or more protected networks, such as distance learning centers (or DLCs) that are connected to the RMC through a computer network such as the internet. A combination of existing hardware and software as well as a methodology for detecting and preventing attacks provides a significant advantage in the reliable security of the described networks.

The method and system of the present invention comprises a remote management center (RMC) that is connected to one or more protected networks or DLCs through a global network (e.g. Internet). Each of the protected networks further comprises at least one wireless access point that connects the protected network to the global network, a virtual private network firewall installed at the protected network and connected with the access point, an intrusion prevention software installed at the virtual private network and connected with the access point, and a remote sensor for monitoring communication traffic to and from the protected network. The RMC is further comprised of a RADIUS server (for Remote Authentication Service), (Primary Domain Control Server (for Remote Authentication with User Policy's service) a remote sensor manager, a firewall and virtual private network (VPN) manager, a global management server with management software, and an Intrusion Prevention Manager. The RMC monitors and controls each of the protected networks through its global network/Internet connection. When monitored conditions indicate that an attack is taking place, the RMC can intervene remotely to assist in preventing incursion into the protected network. The RMC may monitor one or more separate protected networks.

Rather than waiting for the actual launch of an attack, one object of the the present invention is to enable security managers to respond immediately to pre-attack conditions and recognize activity to preemptively neutralize any incipient threat to the enterprise. With this type of approach, attacks could be prevented before critical network damage is incurred. In this way, the network would only need to be defended against a finite number of well-known recon techniques, rather than an unlimited range of unknown attacks. Likewise, it is the object of the present invention that the issue of false positives would be virtually eliminated. This proactive strategy will transform the current Intrusion Detection System (IDS) of today into the Intrusion Prevention System (IPS) of tomorrow. This IPS strategy is a significant and innovative feature of the Remote Management Center.

The security provided by the present invention originates from integrating different security measures to counteract the different types of security threats. The security techniques, measures, and capabilities for protecting these sites are inherent in the following network components: Firewalls, Anti-virus protection, RADIUS servers, Wireless LANs with Virtual Private Networking (VPN) and Intrusion Detection, Honeypots, and Intrusion Prevention Systems.

It is an additional object of the present invention that the network management system and methods can provide a network security service package for small businesses because the small business cannot afford a network specialist on staff and seldom has any expertise or knowledge of appropriate methods and procedures for protecting their private LAN network. A complete turnkey system solution with full training and certification of their appropriate personnel can be readily offered. This network security service package for the smaller business market can be expanded for use by individual users and large businesses as well.

It is another object to provide a proven intrusion prevention and detection system, with assessment and recovery capability to armed services, state and local government agencies, financial institutions, commercial information networks, small businesses, and individual users. In fact, any organization that uses data storage on a network should have the same security measures that this invention provides.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims. It is to be understood that both the foregoing general description and the following detailed description are exemplary and explanatory only and are not restrictive of the invention, as claimed. Thus, the present invention comprises a combination of features, steps, and advantages which enable it to overcome various deficiencies of the prior art. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of a preferred embodiment of the present invention, reference will now be made to the accompanying drawings, which form a part of the specification, and wherein:

FIG. 1 illustrates one embodiment of the system for the present invention;

FIG. 2 illustrates one architecture of a protected network or distance learning center; and

FIG. 3 illustrates a block diagram of the remote management center of the present invention.

### DETAILED DESCRIPTION OF THE PREFERRED EMBODIMENT

Reference will now be made in detail to exemplary embodiments of the invention, examples of which are illustrated in the accompanying drawings. Wherever possible, the same reference numbers will be used throughout the drawings to refer to the same or like parts.

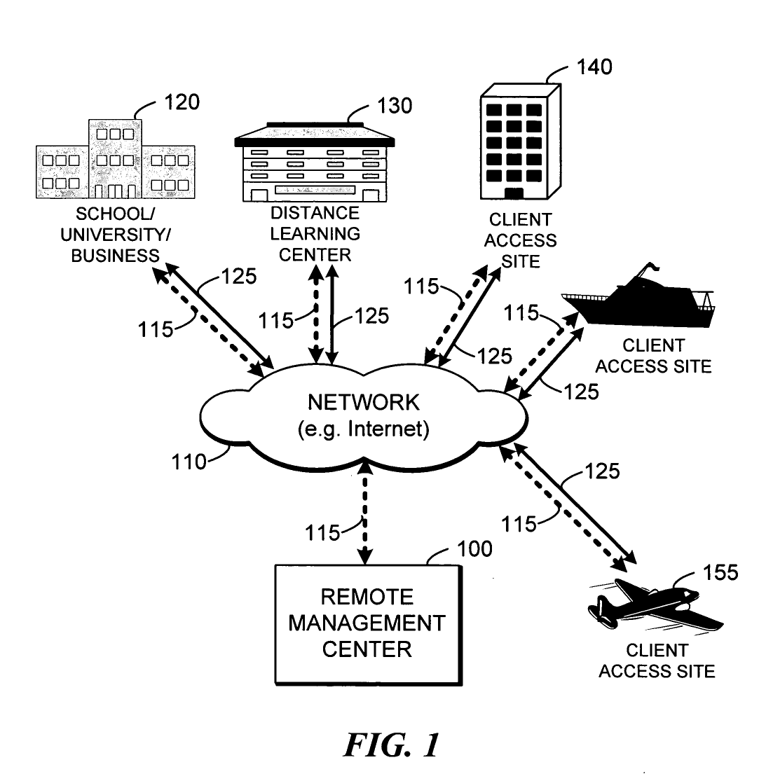

FIG. 1 illustrates an overall conceptual view of one embodiment of the present invention. A remote management center (100) connects to a computer network such as the Internet (110) through a virtual private network connection (115). One or more schools (120), small/medium/large businesses, or distance learning centers (130) as well as one or more client access sites (140), (150), (155) are also connected to the same computer network (110) through virtual private networks (115), (125). Through the embodiment of the present invention client access sites (140), (150) can access schools, small/medium/large businesses and/or distance learning sites (120), (130) through a virtual private networks (125), allowing clients at the client access sites (120), (130) to securely participate in distance learning. Those of skill in the art recognize that network connections (115), (125) can be implemented through a number of conventional means such as wired T1, ISDN, or PSTN lines, or through a wireless interface (such as via satellite link) allowing client access sites (150), (155) to access schools, businesses and/or distance learning centers (120), (130) while mobile and without the need for a direct wired connection. Multiple virtual private networks may exist between clients and or schools/businesses in the present invention, for instance, the remote management center (100) may connect to any client or school or business through the illustrated virtual private network (115). Those of skill in the art also may recognize that any school/university/small/medium/large business (120), distance learning center (130), client access site (140)(150), or remote management center (100) may connect to the computer network (110) through conventional http web service (not shown).

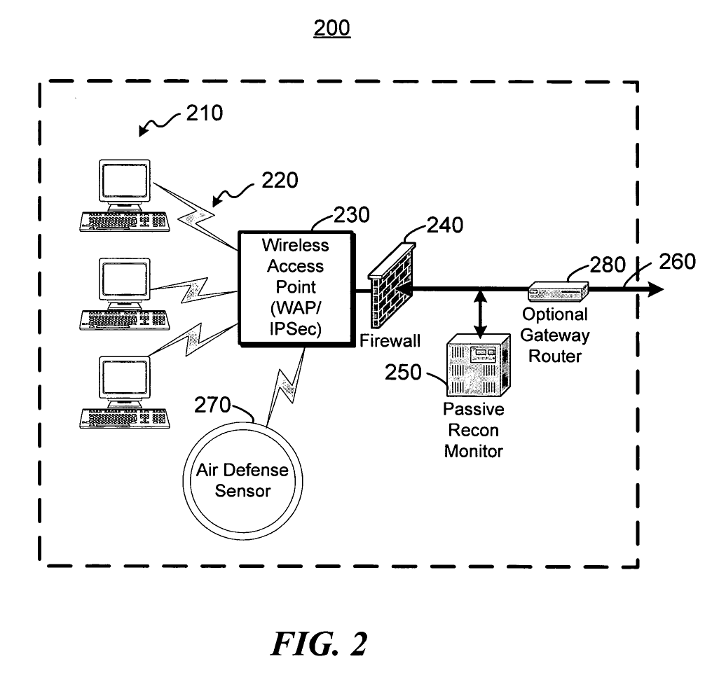

FIG. 2 illustrates a protected network (200) of the present invention that may be implemented through a virtual private network at a school/university business (120), distance learning center (130), or client access site (140, 150) as illustrated in FIG. 1. A plurality of computer workstations (210) is equipped with wireless networking hardware and software that allows them to communicate wirelessly (220) with a Wireless Access Point (WAP/IPsec) (230) and Firewall (240). WAP/IPsec (230) and Firewall (240) may in the alternative be implemented in a single network component such as a Sonicwall Firewall SOH03 TZW or equivalent. In one embodiment, the workstations (210) are Dell workstations or equivalent loaded with Windows Office XP Professional along with Microsoft Office XP standard software. In addition, each workstation (210) may be configured with Anti-virus software along with content filtering software, such as provided by SonicWall or equivalent. Computer video cameras may be installed, one each on work stations (210) along with headsets with microphones.

Each workstation (210) uses WiFiSec encryption to communicate to the WAP/IPsec (230). In one embodiment, the wireless network operates at 11 mbs speed and the WAP/IPsec (230) is connected directly to the Firewall (240). This configuration requires remote management service by the Remote Management Center (RMC) (100) in order to rotate the (WiFiSec) Encryption Keys over a period of time such as every eight hours each day for every workstation (210) and WAP/IPsec Encryption Key. Those of skill in the art recognize that many encryption schemes could be utilized, for example 3DES or AES 256. This will provide enhanced security to eliminate outside access to the protected network (200) via a wireless network implementation.

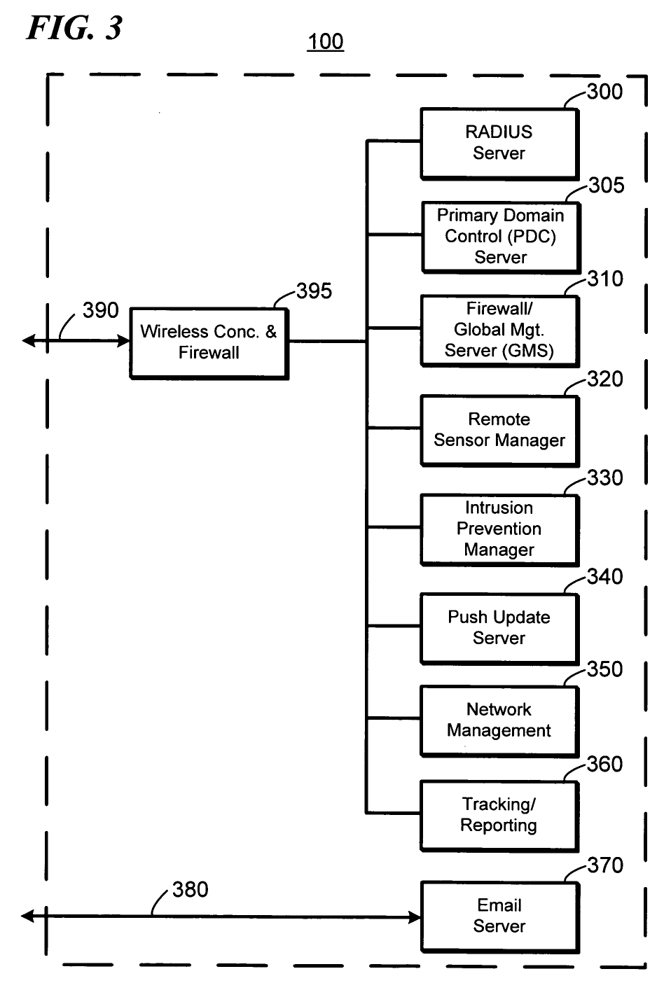

Also in FIG. 2, an intrusion prevention device for passive reconnaissance and monitoring (250) such as the above-described Fore Scout or equivalent product is installed and connected to the firewall via wired connection (260) and that communicates with an intrusion prevention manager (FIG. 3, 330) in the RMC (100). Additionally, a remote sensor appliance (270) monitors wireless communications from the WAP/IPsec (230) and communicates with the remote sensor manager (FIG. 3, 320) in the remote management center (100) described in more detail below. Optionally, a gateway router (280) may be installed in the connection from the firewall (240) to the network connection (260). The operations of the firewall (240) are controlled by the firewall global management server (FIG. 3, 310) in the RMC (100). Installed in the protected network (200) is also automatic patch management software that allows the RMC (100) to install and update patches to software applications as they become available.

Turning to FIG. 3, an illustration of one embodiment of the Remote Management Center (RMC) (100) is shown. The RMC is comprised of several hardware and software elements that allows the RMC administrator to cooperatively monitor and manage remote protected networks (FIG. 2, 200). A Wireless VPN Concentrator and Firewall (395) such as a Pro 3060 or equivalent VPN connects the components of the RMC (100) to the computer network through connection (390). In one embodiment, connection (390) supports operation of a virtual private network implementation. Additional components of the RMC (100) comprise an authentication server (300) such as a RADIUS Server, Primary Domain Control server, a firewall global management server (310), a remote sensor manager appliance (320), an intrusion prevention manager appliance (330), a push update server (340) for providing patches and software updates, a network management application (350), and tracking and reporting software tools (360). Additionally, an email server (370) is provided that connects to the computer network (110) with conventional http web service (380) (without necessity of a virtual private network connection). In an alternate embodiment, the RADIUS server can be replaced by a proprietary implementation such as Microsoft's Internet Authentication Service (IAS).

With regards to FIG. 2 and FIG. 3, the following describes individual modules of the present invention and their interoperation.

Remote Sensors (with IDS)

Remote sensors (FIG. 2., 270) such as those from Air Defense or equivalent are deployed in the proximity of the wireless local area network (WLAN). The remote sensors provide continuous monitoring at the WLAN to identify rogue WLANs, detect intruders and attacks, enforce network security policies, deflect intruders from the network, and monitor the health of the wireless LAN. All activities are reported back to the Remote Sensor Manager Appliance (320) of the RMC (100). Additional products such as the RogueWatch product of Air Defense or equivalent detects rogue Access Points (AP) and other inappropriate, incorrect, or anomalous activity and will respond to both external attacks and internal misuse of computer systems. Rogue Watch provides a multi-dimensional intrusion detection approach that integrates intrusion detection models that combine anomaly and signature-based techniques with policy deviation and state analysis.

RogueWatch provides states analysis for the RMC (100) for the idle, authentication, and association states between the wireless stations and their interactions with Access Points for the RMC (100). RogueWatch also provides a multi-dimensional intrusion detection at the WC (since standard wire-line intrusion detection techniques are not sufficient to protect the wireless network and since wireless protocols are vulnerable to attack).

Wireless VPN and Firewall at the Protected Network

The Wireless VPN functionality and the firewall functionality at the protected network (200) is provided by products such as the SOH03 TZW by SonicWall or equivalent. This product provides VPN Tunneling and provides the capabilities of the firewall. Anti-virus protection functionality is also provided by the SOH03 TZW or equivalent, which takes the anti-virus policy (received from the GMS (310) at the protected network (200)) and pushes an associated anti-virus agent to all the workstations (210). The anti-virus agent in the workstations (210) then performs the anti-virus checks.

The content filtering feature of the firewall (395) allows the administration and control of access policies to be tailored to specific needs, with built-in support for URL filtering, keyword blocking and cookie, Java and ActiveX blocking. A content list subscription service can be employed to insure the proper enforcement of access restrictions. Automatic updates keep the administrator current on the sites containing inappropriate online material.

Intrusion Prevention System Appliance at the Protected Network

The monitor (FIG. 2, 250) such as the Intrusion Protection System (IPS) appliance by Fore Scout is situated behind the gateway router and in front of the firewall (240) at the protected network. From this location, it monitors all traffic heading from the protected network (200) to the RMC (100). This product is configured non-intrusively via a line “tap” or a switch scanning port, thereby allowing it to monitor traffic without introducing any performance degradation. All activity is passed up to the IPS manager component (330) in the RMC (100) for coordination, control, and reporting.

Automated Patch Management Software

A push update server (FIG. 3, 340) such as PatchLink or equivalent Update software package provides automated patch detection and deployment for managing and distributing critical patches that resolve known security vulnerabilities and other stability issues with the operating systems and applications software in the RMC (100) and protected networks (200).

RADIUS Server

The RMC (100) network employs a RADIUS (Remote Authentication Service) server (FIG. 3, 300) to manage authentication, accounting, and access to network resources. The authentication feature of the RADIUS server establishes the identity of users on the Internet to allow VPN access to resources. Digital certificates, widely accepted as the best solution for establishing user identities with absolute confidence, involves a strong authentication of VPN users across the network, (such as through the VeriSign technology for delivery of via use of Public Key Infrastructure (PKI)).

Primary Domain Control (PDC) Server

Primary domain control (PDC) server (FIG. 3, 305) and backup domain controller (BDC) are roles that can be assigned to a server in a network of computers. These functions manage access to a set of network resources (applications, printers, and so forth) for a group of users. The user need only to log in to the domain to gain access to the resources, which may be located on a number of different servers in the network. One server, known as the primary domain controller, manages the master user database for the domain. One or more other servers are designated as backup domain controllers. The primary domain controller periodically sends copies of the database to the backup domain controllers. A backup domain controller can step in as primary domain controller if the PDC server (305) fails and can also help balance the workload if the network is busy enough. Once the authentication has take place at the Radius servers the user then authenticates with a primary domain control (PDC) server (305). Once the user is Authenticated, the PDC Server (305) then returns to the remote system the user's authorized policy. The policy gives the levels of permissible activities the User/System is authorized to perform or not authorize to perform. Any changes to the policy is restricted to the system administrator or authorized party.

Remote Sensor Manager Appliance

The Remote Sensor Manager Appliance (320), such as those by Air Defense, provides the RMC (100) with the capability to coordinate and control the security of the Wireless LANs in the VPN by managing the remote sensors (270) located at the wireless LANs (WLAN). These remote sensors (270) are providing continuous monitoring at the WLAN to identify rogue WLANs, detect intruders and attacks, deflect intruders from the network, and monitor the health of the wireless LAN, and the monitor information is transmitted to the RMC (100) through the virtual private network connection (260), (FIG. 3, 380).

This appliance (320) in the RMC analyzes in real time the activity of the remote sensors (270) at each WLAN so as to discover new or rogue WLANs, attacks, or intruders, and then to alert IT security managers through emails and electronic page if a security threat exists. In this way, intrusion detection, vulnerability assessment, and other security measures of the WLANs of the VPN can be managed and controlled from the RMC (100). Vulnerability assessment is provided at the RMC (100) by the persistent monitoring of the network by this manager to identify weaknesses, and by utilizing the information from each AP in the network.

Wireless VPN Concentrator and Firewall

The RMC (100) network provides VPN and firewall functionality (FIG. 3, 395) though such appliances as the PRO 3060 (by SonicWall) or equivalent. The inherent VPN functionality of the firewall (395) is based on the IPSec (Internet Protocol Security) industry standard and will be compatible with other IPSec-compliant VPN gateways. The firewall component (395) provides a comprehensive, integrated security solution that handles the traffic and users of a large network. This product supports the seamless integration of the associated security applications in the NWUT, including network anti-virus and content filtering.

Global Management System

The RMC employs the Global Management System (GMS) (FIG. 3, 310), such as one by SonicWall or equivalent, for provisioning and managing the protected network (200) or DLC. The GMS system (310) consists of a server loaded with the GMS software. GMS functionality enables the network administrator to define, deploy, and enforce security and VPN policies from a central location. The administration is able to configure the firewall settings and services of the firewall (395), such as VPN, network anti-virus and content filtering. Security policies are centrally pushed by the GMS (310) from the RMC (100) to the firewall and WAP/IPsec (FIG. 2, 230, 240) component in the protected network (200) through a transmission in the computer network (110). The GMS (310) pushes security policies over encrypted VPN tunnels to ensure maximum security for deploying security policies and firmware updates. The pushed policies are thereby installed in the firewall and WAP/IPsec.

The GMS (310) also manages the anti-virus protection, including client auto-installation, virus definition updates, and network-wide policy enforcement. It transparently monitors virus definition files, and automatically triggers new virus definition file downloads and installations for each workstation (210) on the network. This feature ensures that every workstation (201) at the DLC/protected network (200) has the most up-to-date anti-virus software installed and active. This prevents the spread of new viruses or prevents a rogue user from exposing the entire organization to an outbreak. The GMS (310) controls the push of the anti-virus policy to the firewall (240) of the protected network (200). The firewall (240) further controls the anti-virus functionality by pushing an anti-virus agent to the end user workstation (210). The anti-virus agent in the workstation (210) performs the anti-virus checks.

Intrusion Prevention System Manager

An Intrusion Prevention Manager (330), such as one by the ActiveScout Manager product by Fore Scout, is implemented at the RMC (100). The significance of the manager (330) is that it provides intrusion prevention first, then intrusion detection second as necessary. The system of the present invention has a manager server component (330) installed in the RMC (100) and a site-appliance component (FIG. 2, 250) installed in the protected network (200).

The site-appliance component (250) lies behind the gateway router (280) and in front of the firewall (240). From this location, it monitors all traffic heading to the corporate network and reports all activity to the manager component in the RMC (100). It is configured non-intrusively via a line “tap” or a switch spanning port, thereby allowing it to monitor traffic without introducing any performance degradation.

With the intrusion prevention manager at the very edge of the network, the key attack-neutralizing three-phase process is implemented (receptor phase, deceptor phase, and interceptor phase. Information on the network traffic is transmitted to the RMC (100) through the computer network (110). All activity is controlled by the manager (330) in the RMC. All reporting is passed to the manager component (330) from the appliance component (250). Among other actions, the manager (33) can transmit appropriate information to the appliance to assist in the prevention of the intrusion or upon detecting an intrusion condition, provide a security alert to IT personnel.

Tracking and Reporting

The system of the present invention also provides for tracking and reporting (360), through applications such as the Track-it product by Blue Ocean. The tracking and reporting application (360) is installed at the RMC (100) to provide a comprehensive set of tracking and reporting capabilities, including trouble-ticketing, for all relevant activities on the network.

Although an exemplary, preferred embodiment of this invention has been described using preferred commercial products, it will be readily understood by those skilled in the art that modifications of the methods and systems described, as well as substitution of equivalent commercially available products may be made without departure from the spirit and scope of the invention claimed.

What is claimed is:

1. A system for remote network security management, comprising:
a remote management center connected to a global network through a virtual private network connection; and
a protected network connected to said global network and linked to said remote management center through said virtual private network connection, wherein said protected network comprises
at least one wireless access point;
a plurality of workstations;
a wireless intrusion sensor;
a wired intrusion detector;
a firewall; and,
a passive reconnaissance monitor.

2. The remote management center of claim 1 further comprising:
an authentication server;
a global management server;
a remote sensor manager;
an intrusion prevention manager;
a push update server;
a network management application;
a tracking and reporting application;
and a wireless VPN Concentrator and Firewall.

3. The protected network of claim I further comprising a gateway router.

4. A method of providing remote network management comprising:
remotely monitoring and controlling a wireless LAN through a virtual private network connection;
remotely configuring a firewall through said virtual private network connection; and
remotely monitoring network traffic through said virtual private network connection.

5. The method of claim 4 wherein the remotely monitoring and controlling step further comprises:
monitoring a wireless LAN in a protected network through a remote sensor;
transmitting monitor information to a remote management center;
analyzing said monitor information in a remote sensor manager; and
alerting a security manager if a security threat was detected.

6. The method of claim 4 wherein the remotely configuring a firewall step further comprises:
configuring firewall settings and security policies in a remote management center;
transmitting, through encrypted VPN tunnels, said settings and security policies through a computer network to a protected network; and,
installing said settings and security policies in a firewall and wireless access point in said protected network.

7. The method of claim 4 wherein the remotely monitoring network traffic step further comprises:
monitoring network traffic in a site appliance in a protected network;
transmitting network traffic information to an intrusion prevention manager in a remote management center;
determining whether an intrusion condition exists; and transmitting information to the intrusion prevention manager through a computer network.
